(19) United States
(12) Patent Application Publication
(10) Pub. No.: US 2020/0332581 A1
(43) Pub. Date: Oct. 22, 2020

(54) Hinge device for doors, shutters or the like

(71) Applicants: SAVIO S.P.A., Chiusa San Michele (TO) (IT); IN & TEC S.R.L., Brescia (BS) (IT)

(72) Inventors: Aimone Balbo di Vinadio, Chiusa San Michele (TO) (IT); Luciano Bacchetti, Nave (BS) (IT)

(21) Appl. No.: 16/090,067

(22) PCT Filed: Apr. 4, 2017
(86) PCT No.: PCT/IB2017/051914

§ 371 Date: Sep. 28, 2018

(30) Foreign Application Priority Data
Apr. 4, 2016 (IT) 102016000034061

(51) Int. Cl. E05F 3/12; E05F 3/20

(52) U.S. Cl. CPC E05F 3/12; E05Y 2201/264; E05Y 2900/132; E05F 3/20

(57) ABSTRACT

A hinge device includes a fixed element, a movable element, and a slider. One of the fixed or the movable elements defines a working chamber receiving the slider, and the other one has a pivot causing the slider to slide upon a rotation of the pivot. The working chamber contains a working fluid and is separated into a first and a second variable volume compartments by a plunger of the slider, which includes a first valve providing fluid communication between the compartments. A first duct passing through a closing cap of the working chamber has a second valve in fluid communication with the first and second compartments and spaced from the plunger for a first part of a stroke of the plunger. During a second part of the stroke, the plunger acts upon the second valve to cause the closing element to latch toward an open or closed position.

### FIELD OF THE INVENTION

The present invention is generally applicable to the technical field of closing and/or controlling hinges for doors, shutters or similar closing elements, and it particularly relates to a hinge device for rotatably moving and/or controlling during the opening and/or closing a closing element, such as a door, a shutter or the like, anchored to a stationary support structure such as a wall or a frame.

### BACKGROUND OF THE INVENTION

As known, hinges generally comprise a movable element, usually fixed to a door, a shutter or the like, hinged on a fixed element, usually fixed to the support frame thereof, or to a wall and/or to the floor.

From documents U.S. Pat. No. 7,305,797, U.S. 2004/206007 and EP1997994 are known hinges wherein the action of the closing means ensuring the return of the shutter to the closed position is undisputed. From document EP0407150 it is known a door closer that includes hydraulic damping means to counteract the action of the closing means.

Such known devices all have more or less bulk, and, consequently, they have an unpleasant visual impact. Moreover, they do not allow the adjustment of the closing speed and/or of the latch closing of the door, or anyway they do not allow an easy and quick adjustment.

Moreover, such known devices have a large number of constructive parts, that are difficult to manufacture and relatively expensive, as well as they require frequent maintenance.

Other hinges are known from GB19477, U.S. Pat. No. 1,423,784, GB401858, WO03/067011, U.S. 2009/241289, EP0255781, WO2008/50989, EP2241708, CN101705775, GB1516622, U.S. 2011/0041285, WO200713776, WO200636044, WO2006025663 and U.S. 2004/0250377.

From documents GB396673, WO2011/141880 and EP0215264 are also known hydraulic hinges wherein the hydraulic circuit is at least partially contained in the closing cap of the hinge thereof.

Such known hinges may be improved in terms of size and/or reliability and/or performance.

### SUMMARY OF THE INVENTION

Object of the present invention is to at least partially overcome the above-mentioned drawbacks by providing a hinge device of high functionality, constructive simplicity and low cost.

Another object of the invention is to provide a hydraulic hinge device extremely simple to be manufactured.

Another object of the invention is to provide an extremely safe hydraulic hinge device.

Another object of the invention is to provide a low bulkiness hydraulic hinge device.

Another object of the invention is to provide a hydraulic hinge device that ensures the controlled movement of the door whreto it is bound, upon the opening and/or the closing.

Another object of the invention is to provide a hydraulic hinge device having a minimum number of constituent parts.

Another object of the invention is to provide an extremely easy-to-install hydraulic hinge device.

Another object of the invention is to provide a hydraulic hinge device that may be mounted on closing elements having both right and left opening.

Such objects, as well as others that will become more evident hereinafter, are fulfilled by a hinge device having one or more of the features herein described and/or claimed and/or shown.

Advantageous embodiments of the invention are defined according to the appended claims.

### BRIEF DESCRIPTION OF THE DRAWINGS

Further features and advantages of the invention will become more evident by reading the detailed description of some preferred but not exclusive embodiments of a hinge device 1, shown as not limitative example with the help of the annexed drawings, wherein:

FIG. 1A is a top view of an embodiment of the hinge device 1 in an open door position;

FIG. 1B is section view taken along a plane IB-IB in FIG. 1A;

FIG. 1C is an enlarged view of some details of FIG. 1B;

FIG. 2A is a top view of an embodiment of the hinge device 1 in another open door position;

FIG. 2B is a section view taken along a plane IIB-IIB in FIG. 2A;

FIG. 2C is an enlarged view of some details of FIG. 2B;

FIG. 3A is a top view of an embodiment of the hinge device 1 in a closed door position;

FIG. 3B is a section view taken along a plane IIIB-IIIB in FIG. 3A;

FIG. 3C is an enlarged view of some details of FIG. 3B;

FIG. 4 is an axonometric view of an embodiment of the closing cap 27.

### DETAILED DESCRIPTION OF SOME PREFERRED EMBODIMENTS

With reference to the above-mentioned figures, the hinge device 1 is particularly useful for the rotatably moving and/or controlling of a closing element D, such as a door, a shutter, a gate or the like, that may be anchored to a stationary support structure S, such as a wall and/or the frame of a door or of a window and/or a support pillar and/or the floor.

The hinge device 1 may be of a hydraulic type. Depending on the configuration, and in particular on the presence or absence of elastic counteracting means 40, the hinge device 1 may only allow the controlling upon the opening and/or the closing of the closing element D whereto it is bound, or such last action and the automatic closing of the closing element D thereof from the open position.

In the latter case, the elastic means 40 may include a thrust spring with relatively high load. However, the elastic means 40, although present, may include a counteracting spring with relatively low load, whose load does not allow the action of automatic closing.

In general, the hinge device 1 may include a fixed element 10 anchored to the stationary support structure S and a movable element 11 anchored to the closing element D.

Preferably, the hinge device 1 may be configured according to the teachings of one or more of patent applications PCT/IB2012/051707, PCT/IB2013/059120, PCT/IB2013/059121 and VI2013A000245, all on behalf of the same Applicant.

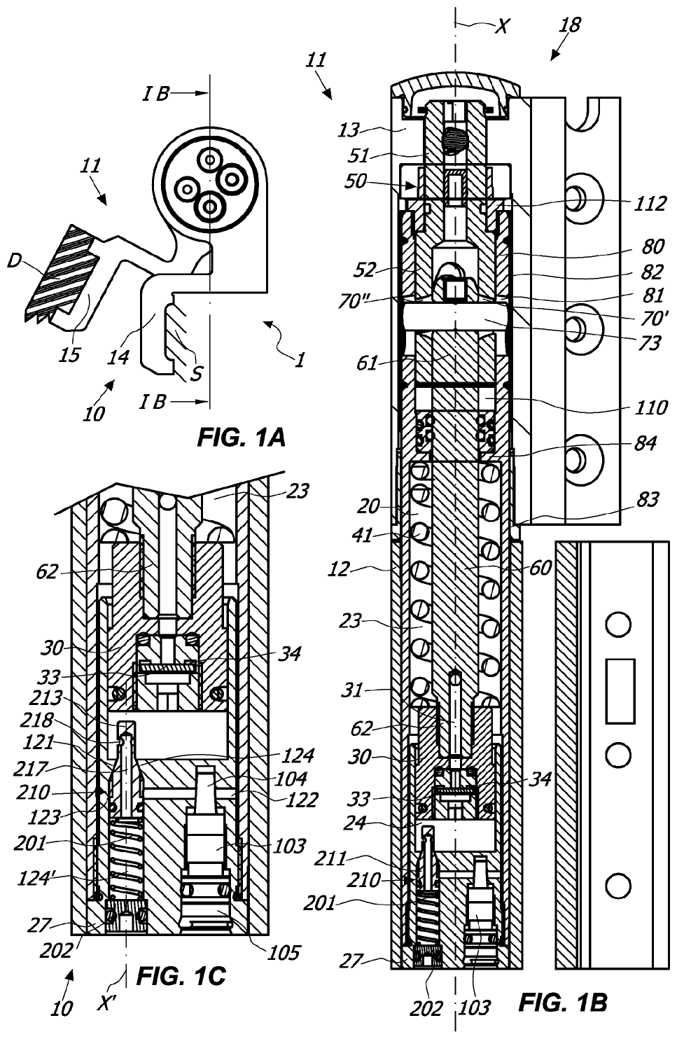

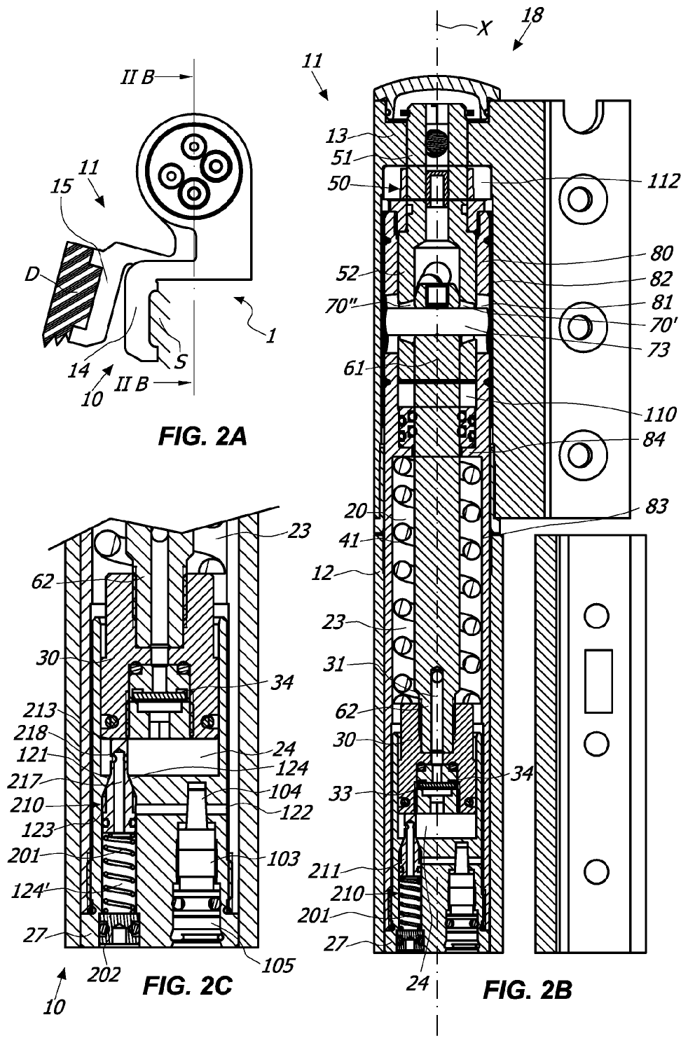

In particular, in a preferred but not exclusive embodiment, the fixed 10 and movable 11 elements of the hinge device 1 may include a hinge body 18 with a respective first and second tubular half-shells 12, 13 reciprocally coupled to rotate around a longitudinal axis X between an open position, shown, for example, in FIGS. 2a and 6a, and a closed position, shown, for example, in FIGS. 1a and 5a.

Suitably, the fixed 10 and movable 11 elements may include a respective first and second fastening wing 14, 15 respectively connected to the first and second tubular half-shell 12, 13 to anchor the stationary support structure S to the closing element D.

Preferably, the hinge device 1 may be configured as a hinge of the “Anuba” type.

More particularly, the hinge device 1 may be at least partially manufactured according to the teachings of one or more of patent applications PCT/IB2011/051688, PCT/IB2012/051707, PCT/IB2013/059120, PCT/IB2013/059121 and/or PCT/IB2014/065078.

Advantageously, with the exception of the fastening wings 14, 15, all the other components of the hinge device 1 may be included within the first and the second tubular half-shell 12, 13.

In particular, the first fixed tubular half-shell 12 may include a working chamber 20 defining the axis X and a plunger member 30 sliding therein. Suitably, the working chamber 20 may be closed at the bottom by a closing cap 27 inserted in the tubular half-shell 12.

It is understood that the axis of rotation of the fixed and movable elements and the axis of sliding of the plunger member may be parallel, perpendicular or coincident therebetween without departing from the scope of protection of the appended claims.

Moreover, the first fixed tubular half-shell 12 may include a working fluid, generally oil, acting upon the plunger member 30 to hydraulically counteract the action thereof. Preferably, moreover, the first fixed tubular half-shell 12 may comprise elastic counteracting means 40, such as a compression helical spring 41, acting upon the plunger member thereof 30.

Suitably, outside the working chamber 20 and coaxially thereto a pivot 50 may be provided, that may advantageously act as an actuator.

In the preferred but not exclusive embodiment shown in FIGS. 1A to 3B, the pivot 50 may be supported by a support portion 84 realized in correspondence to the inner wall 83 of the hinge body 18, as explained hereinafter.

The end portion 51 of the pivot 50 allows the coaxial coupling, preferably of a removable type, between the same pivot and the second movable tubular half-shell 13 so as the latter and the pivot 50 integrally rotate between the open and the closed positions of the movable tubular half-shell 13.

Suitablly, the plunger member 30 and the pivot 50 may be operatively connected therebetween by means of the elongated cylindrical element 60 so that the rotation of the latter around the axis X corresponds to the sliding of the former along the axis X thereof and vice ersa.

To the object, the elongated cylindrical element 60 may include a first end portion 61 reciprocally connected to the plunger member 30 and a second end portion 62 slidable inside the tubular body 52 of the pivot 50.

The connection between the elongated cylindrical element 60 and the plunger member 30 may make such elements integral so as they may define a slider movable along the axis X.

Therefore, the elongated cylindrical element 60 may slide along the axis X integrally with the plunger member 30. Suitably, the elongated cylindrical element 60 and the pivot 50 may be reciprocally telescopically coupled.

Furthermore, the cylindrical elongated element 60 with the respective plunger member 30 may or may not be rotatably blocked in the working chamber 20 to avoid rotations around the axis X during the sliding thereof along the latter. This happens depending on the configuration of the guiding cam slot 81 of the bush 80.

Therefore, with respect to the pivot 50, the plunger member 30 may slide along the axis X between an end-stroke position proximal thereto, corresponding to one of the open and closed positions of the second movable tubular half-shell 13, and an end-stroke position distal to the pivot 50, corresponding to the other of the open and closed positions of the second movable tubular half-shell 13.

To allow the reciprocal movement between the plunger member 30 and the pivot 50, the tubular body 52 of the latter may include at least a pair of grooves 70′, 70″ equal to each other angularly spaced of 180°, each comprising at least one helical portion evolving around the axis X. The grooves 70′, 70″ may communicate to define a single passing-through actuator element 72.

Suitably, the at least one helical portion may have any inclination, and may have a right-handed path, respectively a left-handed path. Preferably, the at least one helical portion may develop for at least 90° around the axis, X and even more preferably for at least 180°.

In a preferred but non-exclusive embodiment, each of the grooves 70′, 70″ may consist of a single helical portion, possibly with a constant inclination or helical pitch.

Suitably, the actuator element 72 may be closed at both ends so as to define a closed path having two blocking end points for the plug 73 sliding therethrough, the closed path being defined by the grooves 70′, 70″.

Regardless of the position or configuration thereof, the actuator passing-through element 72 rotating around the axis X allows the reciprocal movement between the pivot 50 and the plunger member 30.

To guide such a rotation, a guiding tubular bush 80 may be provided coaxially placed outside the tubular body 52 of the pivot 50. The guiding bush 80 may include a pair of cam slots 81 angularly spaced of 180°.

Although in the preferred but not exclusive embodiment shown in the annexed figures the guiding bush 80 is monolithic with the tubular half-shell 12, it is understood that such parts may also be two separate pieces coupled together without departing from the scope of protection of the appended claims.

To allow the reciprocal connection between the pivot 50, the elongated element 60 and the guiding bush 80, the second end portion 62 of the elongated element 60 may include a plug 73 inserted in the passing-through actuator element 72 and in the cam slots 81 to slide therein.

Therefore, the length of the plug 73 may be such to allow such a function. Therefore, upon the rotation of the passing-through actuator element 72, the plug 73 is moved by the latter and guided by the cam slots 81.

Regardless of the shape of the cam slots 81, the latter may be closed at both ends so as to define a closed path having two end blocking points for the plug 73 sliding therethrough.

In order to minimize the friction between the moving parts, at least one anti-friction element may be provided, for example an annular bearing 110, interposed between the pivot 50 and the support portion 84 of the bush 80.

As above-mentioned, in fact, thanks to the configuration above, the plug 73 is pulled down dragging the pivot 50 therewith so that the latter rotates around the axis X on the bearing 110 with minimum friction.

Moreover, at least one further anti-friction element may be provided, for example a further annular bearing 112, interposed between the bush 80 and the second tubular half-shell 13, so that the latter rotates around the axis X on the bearing 112.

Therefore, the bearing 112 lays on the upper portion of the bush 80 so as the pivot 50 is not affected by the weight of the closing element upon the rotation thereof around the axis X.

Preferably, moreover, the bush 80 and the second tubular-half shell 13 may be in a reciprocal spatial relationship such that the second tubular half-shell 13 once coupled to the bush 80 remains spaced apart from the first tubular half-shell 12, for example of a distance equal to some tenth of a millimeter.

As above-mentioned, the hinge device 1 may include a working fluid, such as oil.

Advantageously, one or more sealing elements 22 may be provided to prevent it from spilling, for example one or more o-rings.

The plunger member 30 may be susceptible to separate the working chamber 20 in at least two variable volume compartments 23, 24 fluidly communicating therebetween and preferably adjacent. Suitably, when present, the elastic counteracting means 40 may be inserted in the compartment 23.

In a first preferred but not exclusive embodiment, the elastic counteracting means 40 may be interposed between the pivot 50 and the plunger member 30. For example, the elastic counteracting means 40 may include a spring fitted on the elongated element 60.

To allow the passage of the working fluid between the compartments 23, 24, the plunger member 30 may comprise a passing-through opening 31 and valve means, that may include a disc 33 inserted with a minimum play in a suitable housing 34 to axially move along the axis X. The assembly disc 33—housing 34 defines a non-return valve 32 to intercept the working fluid.

Depending on the direction wherewith the non-return valve is mounted, it may open upon the opening or the closing of the closing element D, so as to allow the passage of the working fluid between the compartment 23 and the compartment 24 during one of the opening or closing of the closing element D and to prevent the backflow thereof during the other of thr opening or closing thereof.

For the controlled backflow of the working fluid between the compartment 23 and the compartment 24 during the other of the opening or closing of the closing element D, a suitable hydraulic circuit 100 may be provided.

Suitably, the plunger member 30 may include, respectively may consist of, a cylindrical body sealingly inserted in the working chamber 20 and faced to the inner side wall 25 thereof.

Moreover, the hydraulic circuit 100 may include a duct 120 passing through the closing cap 27 that includes an opening 121 fluidly communicating with the compartment 24 and an opening 122 fluidly communicating with the compartment 23.

Moreover, the hydraulic circuit 100 may further include further ducts 150 and 130 passing through the closing cap 27 to put in fluid communication the compartment 23 and the compartment 24.

Suitably, the closing cap 27 may further include valve means 140 acting upon the duct 130 to selectively open when the pressure PC in the working chamber 20 exceeds a predetermined threshold value PT.

To protect the integrity of the closing element D that mounts the hinge device 1, the threshold value PT may be calibrated so as to avoid the unhinging of the closing element D thereof by a user who forces the opening and/or closing thereof. In practice, the duct 130 in cooperation with the valve means 140 define an overpressure valve for the hinge device 1.

Suitably, the valve means 140 may be manufactured according to the teachings of the International Application PCT/IB2015/057625, whereto reference is made for consultation.

On the other hand, an adjustment element 170 may be inserted in the duct 150 having an end 171 interacting with the duct 150 thereof and an end 172 operable from the outside by a user to adjust the passage section of the working fluid passing therethrough.

Suitably, the adjustment element 170 may be manufactured according to the teachings of the International Application PCT/IB2015/057625, whereto reference is made for consultation. More particularly, the adjustment element 170 may adjust the closing/opening speed of the closing element D.

It is understood that although the annexed figures show an embodiment of the closing cap 27 including three ducts 120, 130 and 150, the closing cap 27 may also include only the duct 120, or the latter and only one of duct 130 or 150, or other ducts, without departing from the scope of protection of the appended claims.

In a preferred but not exclusive embodiment, the closing cap 27 may include an elongated tubular wall 28 extending inside the working chamber 20. In this case, the hydraulic circuit 100 may include the tubular interspace 29 between the working chamber 20 and the elongated tubular wall 28 of the closing cap 27.

Suitably, the plunger member 30 may be sealingly inserted in the elongated tubular wall 28, while the elongated tubular wall 28 may be inserted into the working chamber 20 with a predetermined tolerance so as the tubular interspace 29 is defined therebetween.

Preferably, the length of the elongated tubular wall 28 may be equal to or greater than the stroke of the plunger member so as the compartment 24 is defined inside the elongated tubular wall 28. More paricularly, the compartment 24 may have a top wall defined by the plunger member 30, a lower wall defined by the closing cap 27 and a side wall defined by the elongated tubular wall 28 of the cap 27 thereof.

Preferably, the elongated tubular wall 28 may be monolithically coupled to the closing cap 27 so as the screwing of the latter in the hinge body 18 defines the hydraulic circuit 100. In fact, the latter consists exclusively of the cavity 29 between the working chamber 20 and the elongated tubular wall 28 and of the ducts 120, 130 and 150.

Since the plunger member 30 and the elongated tubular wall 28 are sealingly inserted in one another and the working chamber 20 and the elongated tubular wall 28 define the cavity 29, the assemblies cavity 29—duct 120, cavity 29—duct 130 and cavity 29—duct 150 define respective independent hydraulic circuits.

In a preferred but not exclusive embodiment, when the working chamber 20 is pressurized, for example during the opening of the door, the valve means 32 open to make the working fluid pass from the compartment 23 to the compartment 24. On the other hand, during the closing of the door, the valve means 32 close, forcing the working fluid from the compartment 24 into the ducts 120, 130 and 150.

It is understood that the valve means 32 may also operate at the opposite, or even be absent, so as the oil may flow from one compartment to the other in a reverse way with respect to the aforementioned, without departing from the scope of protection of the appended claims.

In the case described above, particularly with refernce to the duct 120, the opening 121 defines the inlet of the working fluid therein from the compartment 24, while the opening 122 defines the outlet of duct 120. It is evident that the working fluid passing through the outlet 122 goes back through the tubular cavity 29 and flows into the variable volume compartment 23.

The passage of the working fluid through the opening 121 may be of a selective type, that is, it occurs only and exclusively upon the occurrence of certain conditions.

To the object, valve means 200 may be provided interacting the opening 121 to keep it normally closed.

More in particular, the valve means 200 may include a stopper 210 inserted in an enlarged portion 123 of the duct 120 defining a seat to receive it. In corrispondence to such a seat 123 a passing-through hole 124′ may be provided wherein the stopper 210 may be sealingly inserted.

In a preferred but not exclusive embodiment, the stopper 210 may include, respectively may consist of, an elongated body 211 having a shaped central portion 212 susceptible to couple to a corresponding counter-shaped portion 124 of the seat 123 to close the opening 121.

Furthermore, the elongated body 211 may include a first end portion 213 sucpetible to lay in the compartment 24 when the shaped portion 212 closes the opening 121.

Furthermore, the elongated body 211 may include an end portion 214 opposite to the first end portion 213 that includes an annular projection 215 suceptible to receive a sealing O-ring 21. The end portion 214 may abut against a spring 201.

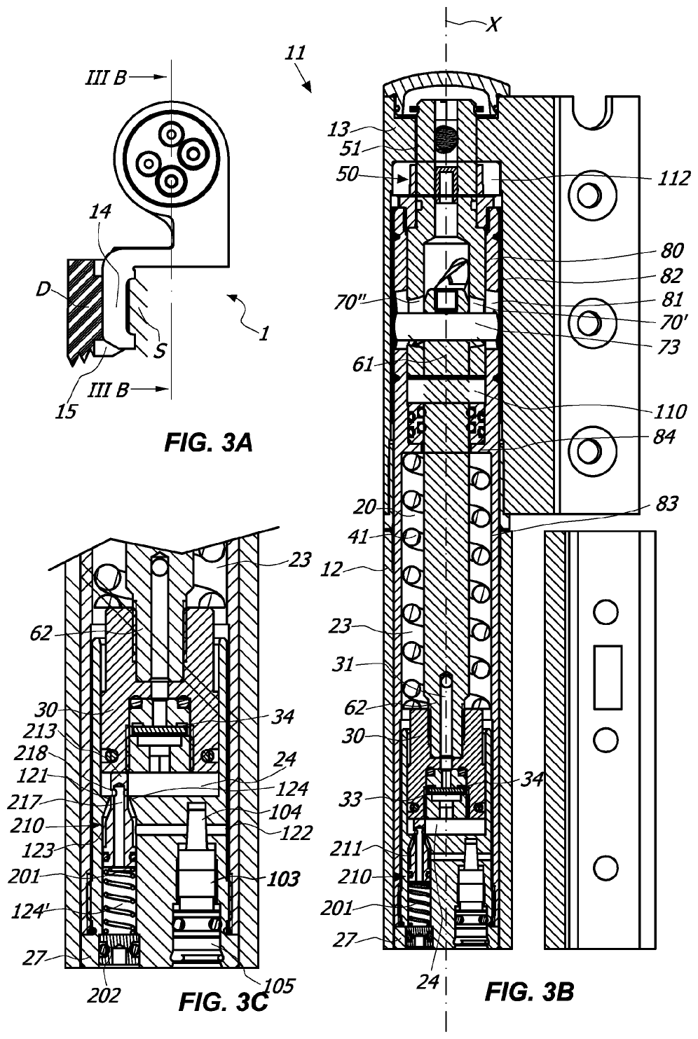

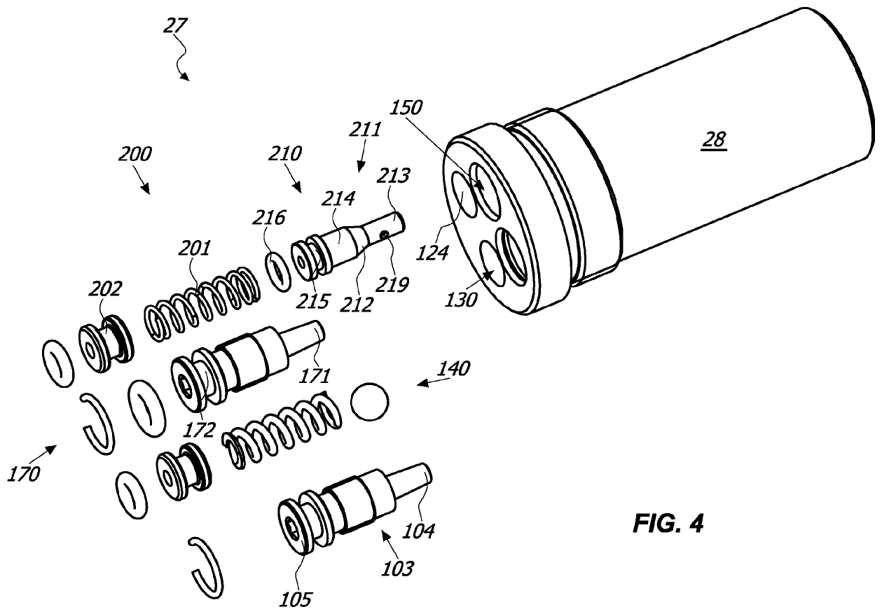

Suitably, the stopper 210 and the plunger member 30 may be in a spacial relationship such that they remain reciprocally spaced apart (FIG. 1C) for a first part of the stroke of the plunger member 30 thereof corresponding for example to a first step of the stroke upon the closing of the plunger member thereof 30, and such that for a second part of the stroke of the plunger member thereof 30 the latter acts upon the first end portion 213 of the stopper 210 to open the opening 121 (FIGS. 2C-3C)

This provokes a sudden flow of working fluid in the compartment 24, that makes the closing element D moving towards the closed position.

Certainly, by appropriately dimensioning the valve means 200 and the plunger member 30, it is possible to adjust the position from which the opening 121 is opened, and, therefore, the angular position wherefrom the closing element D moves to the closed position.

Thanks to such features, it is possible to obtain the latch of the closing element in a simple and practical way, without piercing the hinge body. Therefore, it is possible to obtain vary low bulky hinges both in terms of diameter and length.

Preferably, an adjustment grain 202 may be provided acting upon the spring 201 to allow an operator to adjust the preload thereof and, therefore, the elastic force thereof.

In a preferred but not exclusive embodiment, the elongated body 211 may internally include a channel 217 to keep in fluid communication the compartments 23 and 24 through the duct 120 when the opening 121 is closed.

The inner channel 217 may include a port 218 at the first end portion 213 in fluid communication with said compartment 24 and a port 219 in fluid communication with the seat 123.

The inner channel 217 allows the stopper 210 to remain forced against the opening 121. In fact, when the latter is closed, the pressure acting on the lower end portion 214 is, in fact, greater than the one acting on the upper end portion 213. Therefore, the pressure of the working fluid keeps the opening 121 closed until the plunger member 30 impacts against the stopper 210, thus opening it. In such a case, the spring 201 may be a restore spring, susceptible to make the stopper 210 moving back against the opening 121 once the action of the plunger member 30 is finished.

It is understood that in the embodiment wherein the stopper 210 has no inner channel, the stopper thereof 210 may be elastically forced against the opening 121 by the spring 201. In such a case, the latter may be a thrust spring.

Advantageously, an adjustment element 103 may be inserted into the duct 120 having an end 104 preferably truncated-cone shaped interacting with the duct thereof 120 and an end 105 operatable from the outside by a user to adjust the cross section of the working fluid passing therethrough.

The adjusting element 103 may thus adjust the intensity with which the closing element D latches towards the closed position.

Although in the annexed figures the two adjustment elements 103 and 170 are substantially parallel to the axis X, they may also be substantially perpendicular thereto without departing from the scope of protection of the appended claims.

Therefore, the adjustment element 103 may be susceptible to adjust the closing or opening speed of the closing element D, while the adjustment element 170 may be susceptible to adjust the power of the latch of the closing element D towards the closed or open position.

Moreover, the ducts 130, 120, 150 may also be reciprocally misaligned.

This allows the two adjustment elements 103, 170, the overpressure valve means 140 and the valve means 200 to be in an extremely small space.

For the aforementioned, the closing cap 27 may allow to obtain an extremely safe hinge device thanks to the overpressure valve means 140 and easily adjustable both in speed and in latch thanks to the adjustment elements 103, 170, requiring a very small space.

The closing cap 27 and the respective tubular wall 28 are simple to manufacture and do not require any special making.

Moreover, thanks to the above-mentioned features it is possible to obtain very low bulky hinges.

For the aforementioned, it is evident that the invention fulfills the intended objects.

The invention is susceptible of numerous modifications and variations, all falling within the inventive concept expressed in the appended claims. All the details may be replaced by other technically equivalent elements and the materials may be different according to requirements without departing from the scope of protection of the invention defined in the appended claims.

1.-10. (canceled)

11. A hinge device for rotatably moving and controlling a closing element anchored to a stationary support structure during closing, the hinge device comprising:
a fixed element anchorable to the stationary support structure;
a movable element anchorable to the closing element, said movable element and said fixed element being reciprocally coupled to rotate around a first longitudinal axis between an open position and a closed position; and
a plunger member slidable along a second longitudinal axis between a first end-stroke position, corresponding to one of said closed or said open positions, and a second end-stroke position, corresponding to the other one of said closed or said open positions;
wherein one of said fixed element or movable element comprises a working chamber defined along said second longitudinal axis to slidably house said plunger member, said working chamber having a closing cap,
wherein said working chamber houses a working fluid acting upon said plunger member to hydraulically counteract an action thereof, said plunger member separating said working chamber into a first and a second variable volume compartments fluidly communicating with each other, said plunger member allowing passage of the working fluid between said first compartment and said second compartment during an opening of the closing element, a hydraulic circuit being provided that allows the passage of the working fluid between said first compartment and said second compartment during a closing of the closing element;
wherein said hydraulic circuit includes a first duct and a second duct passing through said closing cap that are fluidly independent of each other, said first duct comprising a opening for selective passage of said working fluid, said closing cap further including a valve interacting with said first opening to keep said first opening closed, said plunger member being in a spatial relationship so as to remain spaced apart for a first part of a closing stroke of said plunger member and to force the working fluid to exclusively pass through said second duct, and, for a second part of the closing stroke of the plunger member, have the plunger member act upon the valve to open said first opening, so that the working fluid passing through both said first duct and said second duct promotes a latching of the closing element toward the closed position.

12. The hinge device according to claim 11, wherein said valve includes a stopper engaging said first opening, said plunger member during the second part of the closing stroke acting upon said stopper to disengage said from said first opening.

13. The hinge device according to claim 12, wherein said stopper includes a first end portion susceptible to lay in said one of said first compartment or said second compartment when said first opening is closed, said first end portion being further susceptible to interact with said plunger member during the second part of the closing stroke.

14. The hinge device according to claim 13, wherein said stopper includes a channel maintaining said first compartment and said second compartment in fluid communication through said first duct when said first opening is closed.

15. The hinge device according to claim 14, wherein said channel includes a first port at said first end portion in fluid communication with said compartment and said second compartment, and a second port in fluid communication with said first duct.

16. The hinge device according to claim 13, wherein said valve includes a spring acting upon said stopper.

17. The hinge device according to claim 16, wherein said first duct has a seat adapted to receive at least partially said valve, said seat including said first opening, said stopper including an elongated body defining a third longitudinal axis essentially parallel to said second longitudinal axis (X) and slidably inserted in said seat, said elongated body including said first end portion, a central shaped portion adapted to couple with a corresponding countershaped portion of said seat to close said first opening , and a second end portion interacting with said spring.

18. The hinge device according to claim 17, wherein said closing cap includes a pass-through hole in correspondence of said seat, said elongated body being sealingly inserted in said pass-through hole, the pass-through hole further housing said spring.

19. The hinge device according claim 11, wherein said closing cap further includes a first adjustment element having a first end interacting with said first duct, and a second end operable from outside by a user to adjust a flow section of the working fluid passing therethrough, so as to adjust a latching force of the closing element toward the open or the closed position.

20. The hinge device according to claim 19, wherein said closing cap further includes a second adjustment element having a third end interacting with said second duct and a fourth end operable from the outside by the user to adjust a passage section of the working fluid passing therethrough, so that the second adjustment element adjusts a closing speed of the closing element.

21. The hinge device according to claim 11, wherein said closing cap includes an elongated tubular wall extending within said working chamber, said elongated tubular wall being monolithic with said closing cap so that an inserting of the closing cap within said working chamber defines said hydraulic circuit, which consists of a gap between said working chamber and said elongated tubular wall and of said first duct passing through said closing cap.
